(19) United States
(12) Patent Application Publication
(10) Pub. No.: US 2008/0195845 A1
(43) Pub. Date: Aug. 14, 2008

(54) DATA PROCESSING SYSTEM HAVING FLEXIBLE INSTRUCTION CAPABILITY AND SELECTION MECHANISM

(75) Inventors: William C. Moyer, Dripping Springs, TX (US); Peter J. Wilson, Leander, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/102,519

(22) Filed: Apr. 14, 2008

Related U.S. Application Data
(62) Division of application No. 11/031,826, filed on Jan. 7, 2005.

(51) Int. Cl. G06F 9/30

(52) U.S. Cl. 712/209; 712/220; 712/E09.016; 712/E09.028

(57) ABSTRACT

If a data processing system (10) implements more than one instruction set within a single processor (12), then program portions encoded using a first instruction set will need to be able to call program portions encoded using a second instruction set. This switching between instruction sets requires that the processor (12) be informed when instruction execution is switching between the plurality of instruction sets. A solution was needed that would allow program portions to freely intermix their usage of different instruction sets with no prior knowledge by the software programmer as to which instruction set is used for which program portion. In one embodiment, instruction address attribute (106) in address mapping circuitry (32) may be used to inform instruction decode unit (46) of processor (12) when instruction execution is switching between the plurality of instruction sets.

### RELATED APPLICATIONS

This is related to U.S. patent application Ser. No. 10/054,577, filed Nov. 13, 2001, assigned to the current assignee hereof, and entitled “METHOD AND APPARATUS FOR INTERFACING A PROCESSOR TO A COPROCESSOR”. This is also related to U.S. patent application Ser. No. 10/127,087 filed Apr. 22, 2002, assigned to the current assignee hereof, and entitled “System for Expanded Instruction Encoding and Method Thereof”.

### FIELD OF THE INVENTION

The present invention relates generally to a data processing system, and more particularly to selecting an instruction set in the data processing system.

### RELATED ART

Certain data processing systems are capable of executing more than a single set of instructions. It is then important to be able to properly select between available instruction sets. It is also important to be able to properly select between available instruction sets as a default when the data processing system exits from a reset state and begins instruction execution.

### BRIEF DESCRIPTION OF THE DRAWINGS

The present invention is illustrated by way of example and not limited by the accompanying figures, in which like references indicate similar elements, and in which:

FIG. 1 illustrates, in block diagram form, a data processing system in accordance with one embodiment of the present invention;

FIG. 2 illustrates, in block diagram form, a portion of processor 12 of FIG. 1 in accordance with one embodiment of the present invention;

FIG. 3 illustrates, in block diagram form, a portion of instruction buffer 40, instruction decode unit 46, and execution unit 50 of FIG. 2 in accordance with one embodiment of the present invention;

FIG. 4 illustrates, in block diagram form, a portion of instruction buffer 40, instruction decode unit 46, and execution unit 50 of FIG. 2 in accordance with an alternate embodiment of the present invention; and

FIG. 5 illustrates, in block diagram form, address mapping circuitry 32 of FIG. 2 in accordance with one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

As used herein, the term “bus” is used to refer to a plurality of signals or conductors which may be used to transfer one or more various types of information, such as data, addresses, control, or status. As used herein, the term “instruction set” is defined to be that collection of one or more instructions that define a particular processor architecture. For example, the MC68HC05 family of processors, available from Freescale Semiconductor Inc. of Austin, Tex. has an instruction set defined in the User's Manual for this particular architecture. Note that instruction sets may overlap, or alternately, they may have no overlapping instructions. Note also that the term “instruction set” as used herein is meant to be processor architecture dependent and is not intended to cover higher level languages (e.g. C, C++, Pascal, Basic, Fortran) which must be compiled before being executed by a processor.

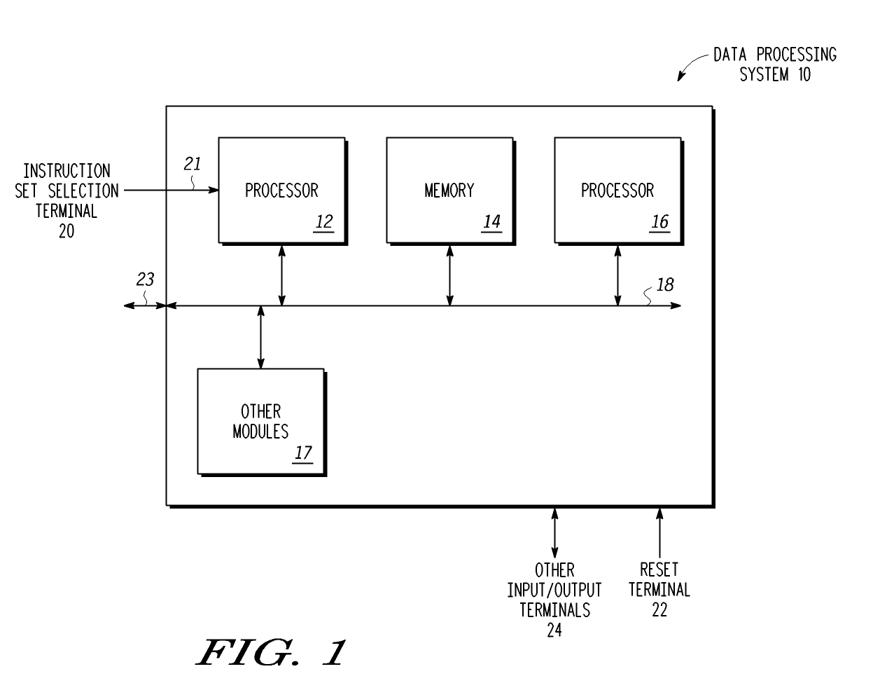

In some processors, it is useful to be able to execute more than one instruction set. For example, the MC68HC05 described above may be a first instruction set. The MC68HC11, also available from Freescale Semiconductor Inc. of Austin, Tex. has an instruction set which is different from the MC68HC05, and may be considered to be a second instruction set. Alternately, the DSP56800E family of digital signal processors available from Freescale Semiconductor Inc. of Austin, Tex. has an instruction set which is different from the MC68HC05, and may instead be considered to be the second instruction set. Alternate embodiments may use any desired instruction set as the first instruction set and may use any desired instruction set as the second instruction set. Note that alternate embodiments may use a processor (e.g. processor 12 in FIG. 1) which is capable of executing even more than two instruction sets.

If a data processing system 10 implements more than one instruction set within a single processor (e.g. processor 12 in FIG. 1), then program portions encoded using a first instruction set will need to be able to call program portions encoded using a second instruction set. This switching between instruction sets requires that processor 12 be timely informed when instruction execution is switching between the plurality of instruction sets. One method is to require that each program portion directly contain a mechanism to specify which instruction set is to be used for that particular program portion. For example, a mode changing instruction in a program portion can be used to specify whether subsequent instructions will be interpreted as part of the first instruction set or as part of the second instruction set.

The problem with this approach is that the programmer of each program portion is required to know ahead of time which program portions called by his/her code will be encoded using instructions from the first instruction set and which will be encoded using instructions from the second instruction set. This problem is quite acute when shared software code libraries are used by a variety of program portions. These shared libraries may be written using instructions from the first instruction set, or alternately may be written using instructions from the second instruction set. The libraries may not even be written yet when a programmer is writing the code for his/her program portion. Thus, it may be impossible to determine which instruction set is used for one or more program portions called by a particular piece of code. This problem may be addressed by compiler/linker technology; but such a solution may be overly cumbersome, may significantly affect the size of the code, and may negatively impact timing and latency constraints. A solution was needed that would allow software code to be written using a plurality of instruction sets, such that program portions could freely intermix their usage of different instruction sets with no prior knowledge as to which instruction set is used for which program portions.

FIG. 1 illustrates a data processing system 10 in accordance with one embodiment of the present invention. In the illustrated embodiment, data processing system 10 has processor 12, memory 14, processor 16, and other modules 17 which are all bi-directionally coupled by way of bus 18. Alternate embodiments of the present invention may use more, less, or different functional blocks that those illustrated in FIG. 1. As some possible examples, alternate embodiments of data processing system 10 may include a timer, a serial peripheral interface, a digital-to-analog converter, an analog-to digital converter, a driver (e.g. a liquid crystal display driver), or a plurality of types of memory. Also, bus 18 may communicate external to data processing system 10 by way of one or more terminals 23.

One or more functional blocks of data processing system 10 (e.g. functional blocks 12, 14, 16, 17) may communicate external to data processing system 10 by way of one or more other input/output terminals 24. Some of these terminals 24 may be input only, some may be output only, and some may be both input and output. Alternate embodiments may not even use other input/output terminals 24. In the illustrated embodiment, data processing system 10 has a reset terminal 22 which is used to receive an externally provided reset signal and to place data processing system 10 into a reset state as a result. Note that some embodiments of data processing system 10 may also be able to place data processing system in a reset state in response to one or more internally generated signals. Processor 12 and/or processor 16 may begin to execute instructions once data processing system 10 exits from a reset state.

In alternate embodiments, data processing system 10 may include one, two, or any number of processors 12, 16. If a plurality of processors 12, 16 are used in data processing system 10, any number of them may be the same, or may be different. Note that although data processing system 10 may have a plurality of processors 12, 16, yet the focus is on a single processor (e.g. processor 12) which by itself can execute a plurality of instruction sets.

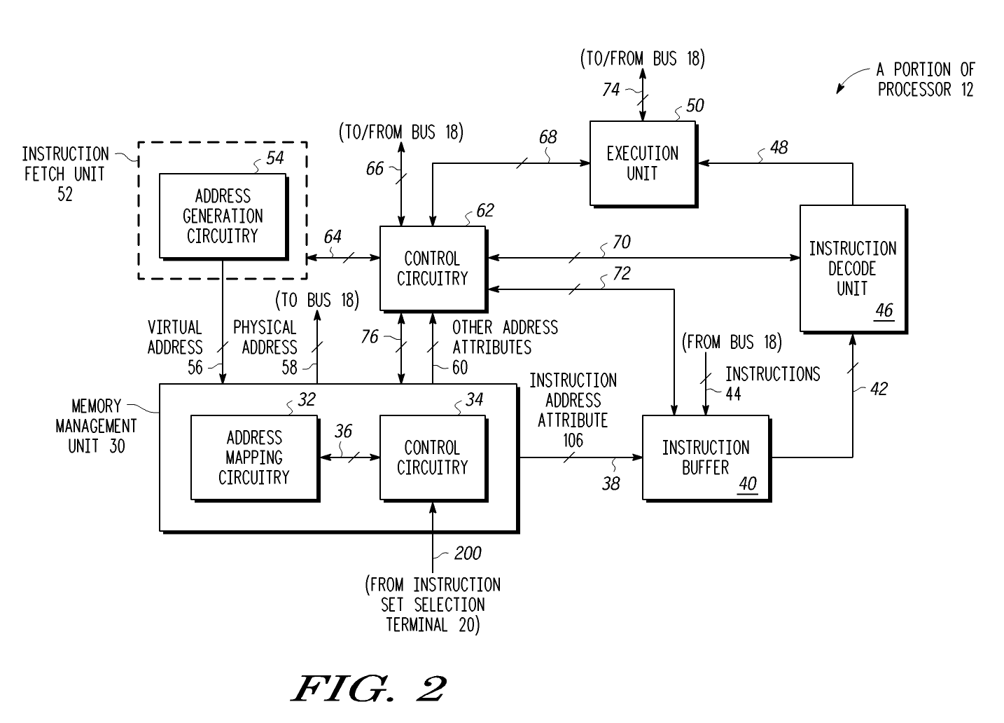

In the illustrated embodiment, processor 12 is coupled to an instruction set selection terminal 20. The instruction set selection terminal 20 receives an instruction set selection signal provided from external to data processing system 10. Instruction set selection terminal 20 then provides the instruction set selection signal to processor 12 by way of one or more conductors (e.g. conductor 21). This instruction set selection terminal 20 may be used by processor 12 to select between a plurality of available instruction sets to determine a default instruction set to first use when the data processing system 12 exits from a reset state and begins executing instructions. Referring to FIG. 2, in one embodiment, control circuitry 62 may receive the instruction set selection signal 21 and may provide one or more signals 70 to instruction decode unit 46 in order to select the default instruction set for processor 12 to first use out of the reset state. Note that in an alternate embodiment, the information regarding which instruction set should be used as a default by processor 12 when coming out of reset may be encoded as part of a package of reset configuration information provided to one or more terminals 20. Such an encoding may more efficiently utilize the terminals (e.g. 20, 22) of data processing system 10.

FIG. 2 illustrates one embodiment of a portion of processor 12 of FIG. 1. Alternate embodiments of processor 12 may use more, less, or different functional blocks that those illustrated in FIG. 2. In the illustrated embodiment, processor 12 has an instruction fetch unit 52 which includes address generation circuitry 54 to generate addresses, along with other circuitry used to perform instruction fetch operations. In one embodiment, address generation circuitry 54 is coupled to memory management unit (MMU) 30 by way of conductor 56 which communicate a virtual address. Memory management unit 30 includes address mapping circuitry 32 and control circuitry 34 which are bi-directionally coupled by way of conductors 36. Control circuitry 34 is coupled to instruction set selection terminal 20 by way of at least one conductor 200. In one embodiment, the instruction set selection terminal 20 receives an instruction set selection signal provided from external to processor 12. Instruction set selection terminal 20 then provides the instruction set selection signal to control circuitry 34 by way of one or more conductors (e.g. conductors 21, 200).

Based on the virtual address 56 the MMU 30 receives, the MMU 30 provides the corresponding physical address to bus 18 by way of conductors 58. Also, based on the virtual address 56 the MMU 30 receives, the MMU 30 provides the corresponding values of the other address attributes to control circuitry 62 by way of one or more conductors 60. In addition, based on the virtual address 56 the MMU 30 receives, the MMU 30 provides the corresponding values of the instruction address attribute 106 to instruction buffer 40 by way of one or more conductors 38. In the illustrated embodiment, MMU 30 is bi-directionally coupled to control circuitry 62 by way of one or more conductors 76 in order to communicate control and status information.

Instruction buffer 40 is coupled to bus 18 to receive instructions 44 to be executed by processor 12. In the illustrated embodiment, MMU 30 is bi-directionally coupled to control circuitry 62 by way of one or more conductors 76 in order to communicate control and status information. In one embodiment, instruction decode unit 46 is coupled to instructions buffer 40 by way of conductors 42. Instruction decode unit 46 is also coupled to control circuitry 62 by way of conductors 70. Instruction decode unit 46 is coupled to execution unit 50 to provide control signals for use in controlling execution unit 50. Note that in some embodiments, control circuitry 62 may be bi-directionally coupled to execution unit 50 by way of conductors 68 in order to communicate control and status information. Alternate embodiments of the present invention may not use conductors 68, but may instead provide all control signals to execution unit 50 by way of instruction decode unit 46. Note that alternate embodiments of the present invention may implement the blocks and functionality of the circuitry illustrated in FIG. 2 in any desired manner. The portion of processor 12 illustrated in FIG. 2 was merely intended as one possible example of circuitry that may be used. Many alternate embodiments are possible.

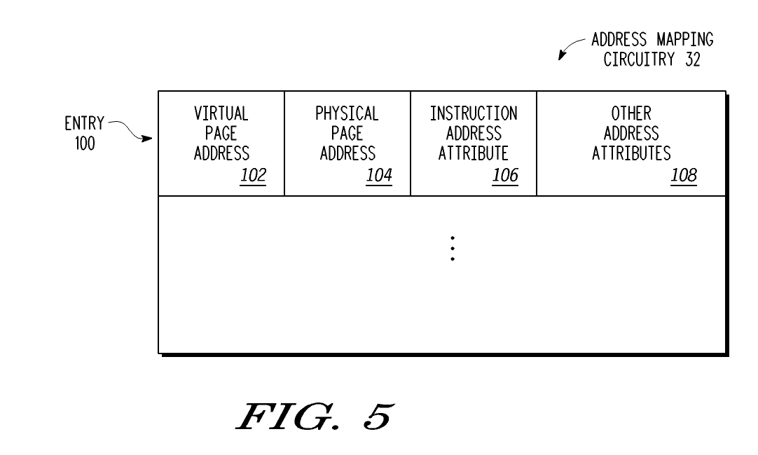

In one embodiment of the circuitry illustrated in FIG. 2, an instruction fetch unit 52 provides a virtual address to memory management unit (MMU) 30. Address mapping circuitry 32 receives this virtual address and compares at least a portion of this received virtual address to the virtual page addresses (e.g. virtual page address 102 of FIG. 5) in order to select an entry (e.g. 100 of FIG. 5) which has a matching virtual page address (e.g. virtual page address 102 of FIG. 5). For ease of illustration herein, it will be assumed that the entry selected in address mapping circuitry 32 is entry 100. This selected entry 100 has a corresponding instruction set address attribute 106. Note that entry 100 also contains a physical page address 104 and other address attributes 108. Some example of other address attributes 108 that may be used are attributes related to endianness, security, memory coherence, cache inhibition, write-through operation, etc.

Referring to FIGS. 2 and 5, entry 100 also provides a physical page address 104 which is provided to bus 18 by way of conductors 58. Note that in some embodiments of the present invention, the complete physical address provided on conductors 58 is a concatenation of a portion of virtual address 56 and physical page address 104. Alternate embodiments may directly map all or a portion of virtual address 56 to be the complete physical address 58 without any address translation being required.

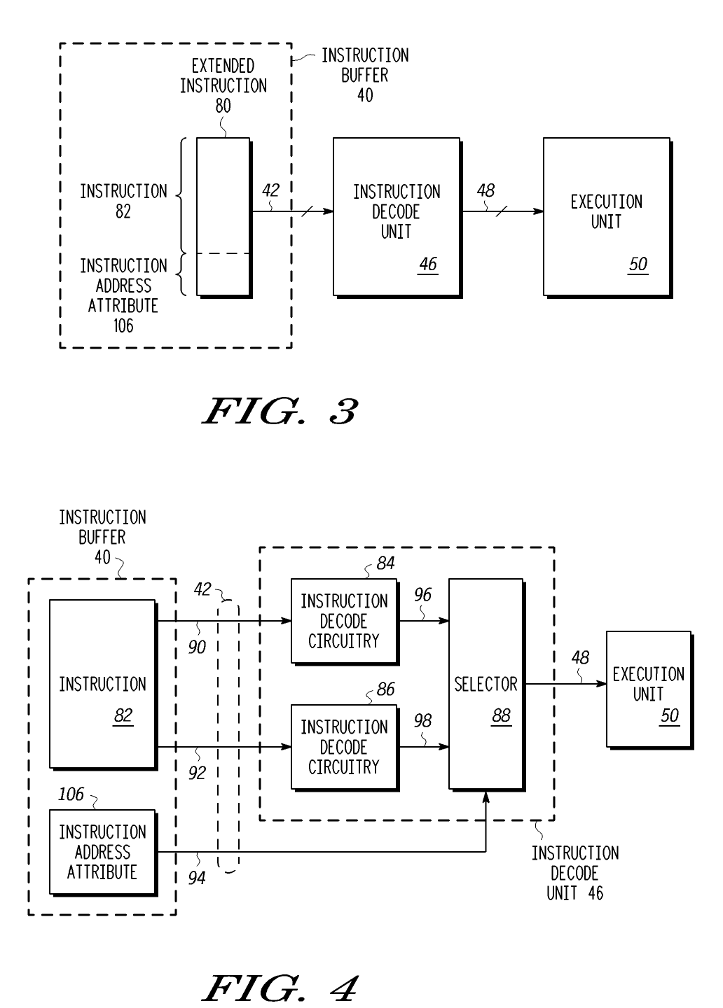

In the embodiment illustrated in FIG. 2, instruction address attribute 106 is provided to instruction buffer 40 by way of conductors 38. Instruction buffer 40 receives instructions from bus 18 by way of conductors 44. There are a variety of ways in which instruction buffer 40 and instruction decode unit 46 may be implemented and function. FIG. 3 illustrated one manner in which instruction buffer 40 and instruction decode unit 46 may be implemented and function, and FIG. 4 illustrates an alternate manner in which instruction buffer 40 and instruction decode unit 46 may be implemented and function.

FIG. 3 illustrates a portion of instruction buffer 40, instruction decode unit 46, and execution unit 50 of FIG. 2 in accordance with one embodiment of the present invention. In the embodiment illustrated in FIG. 3, instruction buffer 40 has an extended instruction 80 which is formed by concatenating instruction 82 and instruction address attribute 106. Note that in this embodiment, there are no longer any instructions executed by processor 12 (see FIG. 1) that use only instruction 82. All instructions executed by processor 12 will now be in the form of extended instruction 80. Instruction decode unit 46 receives extended instruction 80 by way of conductors 42 and decodes extended instruction 80. After performing the decode of extended instruction 80, instruction decode unit 46 provides control signals to execution unit 50 by way of conductors 48. Note that the logic state (e.g. logical “0” or logical “1”) of instruction address attribute 106, which is a portion of extended instruction 80, may be used by instruction decode unit 46 to determine which instruction set is being used, and thus which portion of instruction decode unit 46 will be used to provide control signals 48 to execution unit 50. Note that no special instruction or instruction mode selection mechanism was required. Instead, instruction address attribute 106 itself contains the information regarding which instruction set is to be used and decoded by instruction decode unit 46.

In one embodiment, portion 106 of extended instruction 80 may be provided from control circuitry 34, where the contents of portion 106 is determined by which region of memory sourced portion 106. Which region of memory sourced portion 106 may be determined from the virtual address received by MMU 30. Thus, the address of the region in memory 14 (see FIG. 1) used to store instruction portion 82 may be used by control circuitry 34 to determine instruction portion 106. As a consequence, memory 14 may be used to store a plurality of program portions which are written using different instruction sets. In this embodiment, the region within memory 14 in which a program portion is stored is used to determine instruction address attribute 106, and thus is used to determine the instruction set that is decoded by instruction decode unit 46. Note that memory 14 may store program portions which use one or more instruction sets. For one embodiment, there is only one instruction set per region of memory 14. This means that all instructions stored in that one region of memory 14 are encoded using the same instruction set. Each region in memory 14 may be any desired size, but is generally delineated on byte, word, or long word boundaries. Note that memory 14 will contain one or more regions which may be the same or different sizes.

FIG. 4 illustrates, in block diagram form, a portion of instruction buffer 40, instruction decode unit 46, and execution unit 50 of FIG. 2 in accordance with an alternate embodiment of the present invention. In the embodiment illustrated in FIG. 4, instruction buffer 40 has an instruction circuit 82 that stores a non-extended instruction which has not been modified in any manner. Instruction 82 may be an instruction from the first instruction set, or may be an instruction from the second instruction set. Instruction address attribute 106 in instruction buffer 40 is provided as a control input to selector 88. Note that in this embodiment, processor 12 (see FIG. 1) executes non-extended instructions 82, which include non-modified instructions from both the first instruction set and the second instruction set.

Still referring to FIG. 4, instruction decode unit 84 receives non-extended instruction 82 by way of conductors 42, and instruction decode unit 86 receives non-extended instruction 82 by way of conductors 92. In the illustrated embodiment, both instruction decode circuitry 84 and 86 decode non-extended instruction 82. Instruction decode unit 84 provides decoded control signals 96 intended for execution unit 50 to selector 88, and instruction decode unit 86 provides decoded control signals 98 intended for execution unit 50 to selector 88. The instruction address attributes 106 are then used by selector 88 to determine which signals 96 or 98 are provided by conductors 48 to execution unit 50 to control execution of execution unit 50 during instruction 82.

Note that for one embodiment, the logic state (e.g. logical “0” or logical “1”) of instruction address attribute 106 may be used by selector 88 to determine which instruction set is being used, and thus which instruction decode unit 84 or 86 will be used to provide control signals 48 to execution unit 50. Note that no special instruction or instruction mode selection mechanism was required. Instead, instruction address attribute 106 itself contains the information regarding which instruction set is to be used (i.e. by selecting which instruction decode circuitry 84, 86 is used to provide control signals 48 to execution unit 50). Note that in an alternate embodiment, instruction address attribute 106 may be used to select which instruction decode circuitry 84 or 86 is disabled, and is thus prevented from providing control signals to execution unit 50 by way of conductors 48. In some embodiments, the first instruction set and the second instruction set may include some of the same instructions; and as a result, some portions of instruction decode circuitry 84 and 86 may be the same and produce the same signals on conductors 96 and 98, while other portions of instruction decode circuitry 84 and 86 may be different and produce different signals on conductors 96 and 98.

In one embodiment, portion 106 of extended instruction 80 may be provided from control circuitry 34 (see FIG. 2), where the contents of portion 106 is determined by which region of memory sourced portion 106. Which region of memory sourced portion 106 may be determined from the virtual address received by MMU 30. Thus, the address of the region in memory 14 (see FIG. 1) used to store instruction portion 82 may be used by control circuitry 34 to determine instruction portion 106. As a consequence, memory 14 may be used to store a plurality of program portions which are written using different instruction sets. In this embodiment, the region within memory 14 in which a program portion is stored is used to determine instruction address attribute 106, and thus is used to determine which instruction decode unit 84 or 86 will be used to provide control signals 48 to execution unit 50. Note that memory 14 may store program portions which use one or more instruction sets. For one embodiment, there is only one instruction set per region of memory 14. This means that all instructions stored in that one region of memory 14 are encoded using the same instruction set. Each region in memory 14 may be any desired size, but is generally delineated on byte, word, or long word boundaries. Note that memory 14 will contain one or more regions which may be the same or different sizes.

Referring now to FIGS. 1-4, note that a software programmer using data processing system 10 does not require any awareness of the region within memory 14 in which a program portion is stored. This may be a significant advantage for data processing system 10. Thus, if there are multiple programmers writing software code for data processing system 10, these programmers do not need to modify their software code based on which region within memory 14 stores which program portion used by data processing system 10. The region within memory 14 in which a program portion is stored is thus transparent to the programmer writing software code for data processing system 10. Also, this transparency means that compiler/linker technology is not needed to handle the switching between instruction sets within processor 12. And since the use of compiler/linker technology could significantly increase the complexity and size of the software code, and may negatively impact timing and latency constraints, use of the present invention may be a significant advantage for the performance of data processing system 10.

FIG. 5 illustrates, in block diagram form, address mapping circuitry 32 of FIG. 2 in accordance with one embodiment of the present invention. In the illustrated embodiment, address mapping circuitry 32 includes a plurality of entries (e.g. entry 100). In one embodiment, each entry (e.g. entry 100) has a corresponding virtual page address portion 102, a corresponding physical page address portion 104, a corresponding instruction address attribute portion 106, and a corresponding other address attributes portion 108. The instruction address attribute portion 106 of each entry may have one or more bits. Likewise, portions 102, 104, and 108 of address mapping circuitry 32 may have any number of bits. For one embodiment of address mapping circuitry 32, all of the entries (e.g. entry 100) have a first number of bits in virtual page address portion 102; all of the entries have a second number of bits in physical page address portion 104; all of the entries all have a third number of bits in instruction address attribute portion 106; and, all of the entries all have a fourth number of bits in other address attributes portion 108. Note that the first, second, third, and fourth number of bits may be the same or may be different.

In one embodiment, address mapping circuitry 32 is a translation look-aside buffer (TLB). In one embodiment, address mapping circuitry 32 functions in the same manner as a standard TLB, with the exception of the instruction address attributes 106 which function as described in FIGS. 2-4 and the accompanying text. Referring to FIGS. 2 and 5, in one embodiment, at least a portion of an incoming virtual address 56 is compared to the virtual page address portion 102 of address mapping circuitry 32 to see if there is a match for any entry (e.g. entry 100). If there is a match, the corresponding portions 104, 106, and 108 of that entry (e.g. entry 100) are used. The physical page address portion 104 is then provided as at least a portion of physical address 58. Note that for some embodiments, a portion of virtual address 56 is concatenated to physical page address 104 in order to form physical address 58. Alternate embodiments may form physical address 58 in a different manner. In addition, for alternate embodiments, address mapping circuitry 32 may provide a 1:1 mapping between virtual address 56 and physical address 58. In this embodiment, physical page address portion 104 (see FIG, 5) may not be required. Other address attributes 108 may be used in a prior art manner well known in the art. Some example of other address attributes 108 that may be used are well known prior art address attributes related to endianness, security, memory coherence, cache inhibition, write-through operation, etc.

Note that in alternate embodiments, the instruction set address attribute may be used as an instruction address attribute to select a selected portion of instructions within one or more instructions sets.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. In a processor capable of executing a plurality of instruction sets, a method comprising:
receiving an instruction having a corresponding instruction address;
the processor using the instruction address to select one of the plurality of instruction sets; and
processing the instruction according to the selected instruction set.

2. The method of claim 1, wherein using the instruction address to select the one of the plurality of instruction sets comprises:
determining a region of memory in which the instruction address is located; and
selecting the one of the plurality of instruction sets based on the region of memory, wherein the region of memory corresponds to the one of the plurality of instruction sets.

3. The method of claim 1, wherein using the instruction address to select the one of the plurality of instruction sets comprises:
using the instruction address to select an entry within address mapping circuitry, wherein the entry comprises an instruction address attribute corresponding to the instruction address; and
using the instruction address attribute to select the one of the plurality of instruction sets.

4. The method of claim 3, wherein using the instruction address to select the one of the plurality of instruction sets further comprises:
using the selected entry within address mapping circuitry to provide a translated address corresponding to the instruction address, wherein the received instruction is received from the translated address.

5. The method of claim 3, wherein using the instruction address attribute to select the one of the plurality of instruction sets comprises using the instruction address attribute to select one of a plurality of instruction decode circuitries to decode the instruction, wherein each of the plurality of instruction decode circuitries corresponds to a different one of the plurality of instruction sets, and wherein the selected one of the plurality of instruction decode circuitries corresponds to the selected instruction set.

6-11. (canceled)

12. In a processor capable of executing a plurality of instruction sets, a method comprising:
receiving a virtual address;
translating the virtual address into a physical address;
determining an address attribute corresponding to the virtual address, wherein the address attribute indicates one of the plurality of instruction sets;
receiving an instruction located at the physical address;
processing the received instruction according to the indicated one of the plurality of instruction sets.

13. The method of claim 12, wherein the translating the virtual address comprises using the virtual address to select a corresponding entry in a translation look-aside buffer (TLB), and wherein the corresponding entry in the TLB provides the address attribute.

14. The method of claim 12, wherein the processing the received instruction according to the indicated one of the plurality of instruction sets comprises:
using the address attribute to select one of a plurality of instruction decode circuitries, wherein each of the plurality of instruction decode circuitries corresponds to a different one of the plurality of instruction sets, and wherein the selected one of the plurality of instruction decode circuitries corresponds to the selected instruction set.

15. A processor capable of executing a plurality of instruction sets, comprising:
a memory management unit, the memory management unit receiving an instruction address and providing an instruction address attribute corresponding to the received instruction address, the instruction address attribute indicating one of the plurality of instruction sets;
an instruction decode unit coupled to receive an instruction corresponding to the instruction address and to decode the received instruction according to the indicated one of the plurality of instruction sets.

16. The processor of claim 15, wherein the memory management unit comprises address mapping circuitry, the memory management unit using the address mapping circuitry to provide a physical address corresponding to the received instruction address.

17. The processor of claim 16, wherein the address mapping circuitry stores a physical page address and the instruction address attribute corresponding to the received instruction address.

18. The processor of claim 15, wherein the instruction corresponding to the instruction address is located at the instruction address.

19. The processor of claim 15, wherein the instruction decode unit comprises a plurality of instruction decode circuitries, each of the plurality of instruction decode circuitries corresponding to a different one of the plurality of instruction sets.

20. The processor of claim 19, wherein the instruction is decoded by one of the plurality of instruction decode circuitries selected by the instruction address attribute, wherein the selected one of the plurality of instruction decode circuitries corresponds to the indicated one of the plurality of instruction sets.

21. The processor of claim 19, further comprising an execution unit, wherein each of the plurality of instruction decode circuitries provides a decoded instruction, the instruction address attribute selecting which decoded instruction is provided to the execution unit, and wherein the selected decoded instruction is decoded according to the indicated one of the plurality of instruction sets.

22. The processor of claim 15, wherein the memory management unit determines which memory region of a plurality of memory regions in which the instruction address is located and determines the instruction address attribute based on the memory region in which the instruction address is located.

23-27. (canceled)

28. In a processor capable of executing a plurality of instruction sets, a method comprising:
in response to a reset of the processor, receiving an instruction set selector from an instruction set selection terminal of the processor, the instruction set selector selecting one of the plurality of instruction sets;
receiving an instruction; and
processing the instruction according to the selected one of the plurality of instruction sets.

29. The method of claim 28, wherein the instruction set selection terminal comprises an input pin of the processor.

30. The method of claim 28, further comprising receiving a reset signal from a reset terminal of the processor, wherein the reset of the processor is initiated by the receiving the reset signal.
